(19) United States
(12) Patent Application Publication
(10) Pub. No.: US 2025/0209655 A1
(43) Pub. Date: Jun. 26, 2025

(54) METHOD AND APPARATUS FOR CALCULATING PLANT HEIGHT UNIFORMITY OF CROP POPULATION, DEVICE, AND MEDIUM

(71) Applicant: Information Technology Research Center, Beijing Academy of Agriculture and Forestry Sciences, Beijing (CN)

(72) Inventors: Xinyu GUO, Beijing (CN); Wushuai CHANG, Beijing (CN); Weiliang WEN, Beijing (CN); Jiangchuan FAN, Beijing (CN); Shenghao GU, Beijing (CN)

(21) Appl. No.: 19/000,803

(22) Filed: Dec. 24, 2024

(30) Foreign Application Priority Data
Dec. 26, 2023 (CN) 202311808583.6

(51) Int. Cl. G06T 7/60; G06T 7/11

(52) U.S. Cl. CPC G06T 7/60; G06T 7/11; G06T 2207/10028; G06T 2207/10032; G06T 2207/30188

(57) ABSTRACT

The present application relates to a method and apparatus for calculating a plant height uniformity of a crop population, a device, and a medium. According to the present application, a target crop population is segmented into plots, and the plot is segmented into grids. Since a number of target crop grids is the same as a number of target crop plants in each target crop plot, a plant height uniformity of each target crop plot can be determined according to three-dimensional (3D) point cloud data of the grid, thereby determining a uniformity of the target crop population. The present application realizes automatic and high-spatial-resolution uniformity calculation based on the point cloud data, improves the calculation efficiency, reduces the labor cost, and can expand the calculation area. Meanwhile, the present application can realize non-contact calculation, thereby further improving the availability of the uniformity calculated result.

### CROSS REFERENCE TO RELATED APPLICATION

This patent application claims the benefit and priority of Chinese Patent Application No. 2023118085836, filed with the China National Intellectual Property Administration on Dec. 26, 2023, the disclosure of which is incorporated by reference herein in its entirety as part of the present application.

### TECHNICAL FIELD

The present disclosure relates to the field of agricultural information technologies, and in particular to a method and apparatus for calculating a plant height uniformity of a crop population, a device, and a medium.

### BACKGROUND

In the agricultural field, individual crops often have different phenotypes. In case of a large phenotypic difference between the individual crops, and a low uniformity of the individual crops, the biomass accumulation capacity of the population is reduced, thereby affecting the cultivation effect of the crop population. The high plant height uniformity of the population is helpful to increase the light interception capacity of the population, thereby improving the biomass accumulation. Hence, to calculate the plant height uniformity of the crop population is of great significance to research and actual production, such as evaluation of crop species and evaluation of cultivation management measures.

According to the existing technical solution, the common method for calculating the uniformity is based on actual calculation. For example, plant heights of single crops in the crop population are calculated by sampling, and then a plant height uniformity of the crops is obtained statistically.

However, there are at least the following defects in the prior art: The sampling calculation has a high workload, a limited range and a low spatial resolution, with an accuracy greatly affected by a sampling method. On the other hand, the contact calculation is adverse to the crop growth to cause an inaccurate calculation result.

### SUMMARY

The present disclosure provides a method and apparatus for calculating a plant height uniformity of a crop population, a device, and a medium, to solve the defects of a high workload, a limited range, and a low spatial resolution of the method for calculating the plant height uniformity of the crops by sampling calculation in the prior art, and realize automatic and high-spatial-resolution calculation for the plant height uniformity of the crop population.

The present disclosure provides a method for calculating a plant height uniformity of a crop population, including following steps:
acquiring three-dimensional (3D) point cloud data of a target crop population;
segmenting the 3D point cloud data of the target crop population to obtain 3D point cloud data of each target crop plot;
determining target crop grids according to the 3D point cloud data of each target crop plot, a number of target crop grids being the same as a number of target crop plants in each target crop plot; and
determining a plant height uniformity of each target crop plot according to 3D point cloud data of the target crop grid.

After the acquiring 3D point cloud data of a target crop population, the method for calculating a plant height uniformity of a crop population provided by the present disclosure further includes a preprocessing step, specifically:
determining a ground point cloud according to the 3D point cloud data of the target crop population;
determining a normal direction of the ground point cloud as a reference direction, and rotating the 3D point cloud data of the target crop population, such that a direction of the 3D point cloud data of the target crop population is the same as the reference direction; and
removing the ground point cloud in the 3D point cloud data of the target crop population.

According to the method for calculating a plant height uniformity of a crop population provided by the present disclosure, the determining target crop grids according to the 3D point cloud data of each target crop plot includes:
acquiring a row spacing and a plant spacing of each target crop plot;
dividing the 3D point cloud data of each target crop plot into multiple rows according to the row spacing to obtain a row divided result; and dividing the 3D point cloud data of each target crop plot into multiple columns according to the plant spacing to obtain a column divided result; and
determining the target crop grids according to the row divided result and the column divided result for the 3D point cloud data of each target crop plot, the target crop grid including a length taken as the row spacing, and a width taken as the plant spacing.

According to the method for calculating a plant height uniformity of a crop population provided by the present disclosure, the determining a plant height uniformity of each target crop plot according to 3D point cloud data of the target crop grid includes:
determining a height characteristic index of the target crop grid according to the 3D point cloud data of the target crop grid, the height characteristic index being used for describing a target crop height in the target crop grid; and
determining the plant height uniformity of each target crop plot according to the height characteristic index of each target crop grid in each target crop plot.

According to the method for calculating a plant height uniformity of a crop population provided by the present disclosure, the determining a plant height uniformity of each target crop plot according to 3D point cloud data of the target crop grid includes:
determining a height characteristic index of the target crop grid according to the 3D point cloud data of the target crop grid, the height characteristic index being used for describing a target crop height in the target crop grid; and
determining the plant height uniformity of each target crop plot according to a height characteristic index of a first grid in each target crop plot, where
the first grid is determined as follows:
removing at least one head row of target crop grids and at least one tail row of target crop grids in the row divided result, and removing at least one head column of target crop grids and at least one tail column of target crop grids in the column divided result, thereby obtaining the first grid.

According to the method for calculating a plant height uniformity of a crop population provided by the present disclosure, the determining a height characteristic index of the target crop grid according to the 3D point cloud data of the target crop grid includes:
sorting the 3D point cloud data of the target crop grid according to heights; and
determining the height characteristic index as a height value of a preset quantile according to a height sorted result.

The present disclosure further provides an apparatus for calculating a plant height uniformity of a crop population, including:
a data acquisition module configured to acquire 3D point cloud data of a target crop population;
a plot segmentation module configured to segment the 3D point cloud data of the target crop population to obtain 3D point cloud data of each target crop plot;
a grid module configured to determine target crop grids according to the 3D point cloud data of each target crop plot, a number of target crop grids being the same as a number of target crop plants in each target crop plot; and
a uniformity module configured to determine a plant height uniformity of each target crop plot according to 3D point cloud data of the target crop grid.

The present disclosure further provides an electronic device, including a memory, a processor, and a computer program stored in the memory and executable on the processor, where when the program is executed by the processor, the method for calculating a plant height uniformity of a crop population is implemented.

The present disclosure further provides a non-transitory computer-readable storage medium, storing a computer program, where when the computer program is executed by a processor, the method for calculating a plant height uniformity of a crop population is implemented.

The present disclosure further provides a computer program product, including a computer program, where when the computer program is executed by a processor, the method for calculating a plant height uniformity of a crop population is implemented.

According to the method and apparatus for calculating a plant height uniformity of a crop population, the device, and the medium provided by the present disclosure, a target crop population is segmented into plots, and the plot is segmented into grids. Since a number of target crop grids is the same as a number of target crop plants in each target crop plot, a plant height uniformity of each target crop plot can be determined according to 3D point cloud data of the grid, thereby determining a uniformity of the target crop population. The present disclosure realizes automatic and high-spatial-resolution uniformity calculation based on the point cloud data, improves the calculation efficiency, reduces the labor cost, and can expand the calculation area. Meanwhile, the present disclosure can realize non-contact calculation, thereby further improving the availability of the uniformity calculated result.

### BRIEF DESCRIPTION OF THE DRAWINGS

To describe the technical solutions in the present disclosure or in the prior art more clearly, the accompanying drawings required for describing embodiments or the prior art will be briefly described below. Apparently, the accompanying drawings in the following description show some embodiments of the present disclosure, and a person of ordinary skill in the art may still derive other drawings from these accompanying drawings without creative efforts.

FIG. 1 is a schematic flowchart of a method for calculating a plant height uniformity of a crop population according to the present disclosure;

FIG. 2 is a schematic structural view of an apparatus for calculating a plant height uniformity of a crop population according to the present disclosure; and

FIG. 3 is a structural schematic view of an electronic device according to the present disclosure.

### DETAILED DESCRIPTION OF THE EMBODIMENTS

To make the objectives, technical solutions and advantages of the present disclosure clearer, the following clearly and completely describes the technical solutions in the present disclosure with reference to the accompanying drawings in the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

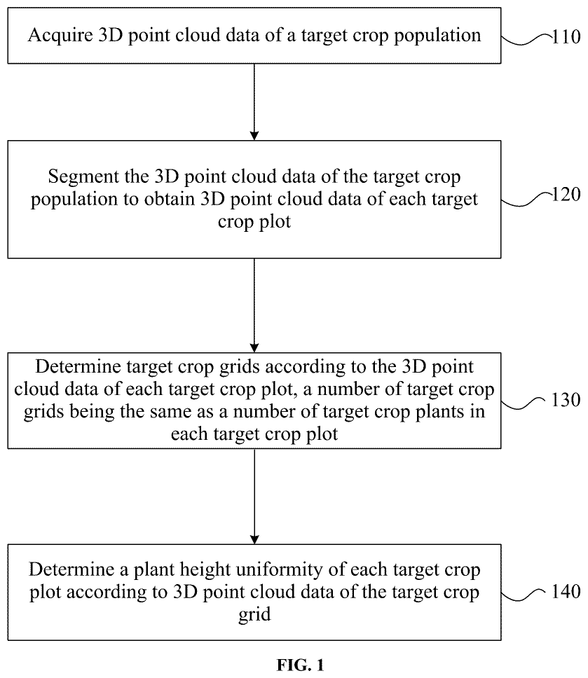

With reference to FIG. 1 to FIG. 3, a method and apparatus for calculating a plant height uniformity of a crop population, a device, and a medium provided by the present disclosure will be described below.

FIG. 1 is a schematic flowchart of a method for calculating a plant height uniformity of a crop population according to the present disclosure. As shown in FIG. 1, the method for calculating a plant height uniformity of a crop population includes Step 110 to Step 140. Specifically:

Step 110: 3D point cloud data of a target crop population is acquired.

Step 120: The 3D point cloud data of the target crop population is segmented to obtain 3D point cloud data of each target crop plot.

Step 130: Target crop grids are determined according to the 3D point cloud data of each target crop plot, a number of target crop grids being the same as a number of target crop plants in each target crop plot.

Step 140: A plant height uniformity of each target crop plot is determined according to 3D point cloud data of the target crop grid.

In the embodiment of the present disclosure, the 3D point cloud data of the target crop population in Step 110 may be acquired by an unmanned aerial vehicle (UAV). For example, the UAV is used to mount a light detection and ranging (LiDAR) to acquire top data of the crop population. The flight height of the UAV falls in a preset range, for example, in a range between 30 m and 15 m. This acquires the point cloud data at a high resolution, and prevents a top of the crop canopy from shaking for an airflow. The 3D point cloud data of the target crop population is further obtained according to the top data of the crop population.

In the embodiment of the present disclosure, Step 120 that the 3D point cloud data of the target crop population is segmented to obtain 3D point cloud data of each target crop plot may include: According to a preset rule, a spatial distribution of the target crop population is divided into multiple plots, thereby segmenting the 3D point cloud data of the target crop population to obtain the 3D point cloud data of the multiple target crop plots. Alternatively, the 3D point cloud data of the target crop population may also be segmented directly according to a preset method to obtain the 3D point cloud data of the multiple target crop plots. In the embodiment of the present disclosure, target crops in the segmented plot should have a same planting rule. That is, target crops in a same plot should be planted in a same row spacing and a same plant spacing.

In the embodiment of the present disclosure, the grids in Step 130 may not be overlapped with each other, and may also be overlapped with each other. It is to be understood that the grids may be set according to species of target crops. For example, for the target crops in which each plant has a large canopy, since the plant is rarely prone to lateral growth, the grids may not be overlapped with each other. For multi-tiller and dense target crops, the grids may be overlapped in a preset range, so as to describe influences of lateral growth of the plants on calculation of the plant height uniformity.

In the embodiment of the present disclosure, in Step 140, the number of target crop grids is the same as the number of target crop plants in each target crop plot where all crops are planted individually and germinated. It can be considered that a distribution of plant heights is associated with a distributed intensity of point clouds of the target crop grids. Hence, the plant height uniformity of each target crop plot can be determined according to the 3D point cloud data of the target crop grid. In the embodiment of the present disclosure, an associated model for the 3D point cloud data and the plant height uniformity can be determined with an agricultural scientific method, a statistical method or a machine learning method, thereby determining the plant height uniformity of each target crop plot.

Therefore, according to Step 110 to Step 140 in the embodiment of the present disclosure, a target crop population is segmented into plots, and the plot is segmented into grids. Since a number of target crop grids is the same as a number of target crop plants in each target crop plot, a plant height uniformity of each target crop plot can be determined according to 3D point cloud data of the grid, thereby determining a uniformity of the target crop population. The present disclosure realizes automatic and high-spatial-resolution uniformity calculation based on the point cloud data, improves the calculation efficiency, reduces the labor cost, and can expand the calculation area. Meanwhile, the present disclosure can realize non-contact calculation, thereby further improving the availability of the uniformity calculated result.

In the embodiment of the present disclosure, after Step 110, the method for measuring a plant height uniformity of a crop population further includes a preprocessing step, specifically:

A ground point cloud is determined according to the 3D point cloud data of the target crop population.

A normal direction of the ground point cloud is determined as a reference direction, and the 3D point cloud data of the target crop population is rotated, such that a direction of the 3D point cloud data of the target crop population is the same as the reference direction.

The ground point cloud in the 3D point cloud data of the target crop population is removed.

Further, in the embodiment of the present disclosure, a coordinate system is established according to the 3D point cloud data of the target crop population, specifically:

A ground center is translated to a plane at a height of 0 (namely, the ground coincides with an XY plane).

The 3D point cloud data of the target crop population is rotated according to a row direction of the crop population in planting, such that the row direction of crops is parallel to an X-axis.

In the embodiment of the present disclosure, a cloth simulation filter (CSF) algorithm or a random sample consensus (RANSAC) algorithm may be used to determine the ground point cloud according to the 3D point cloud data of the target crop population.

In the embodiment of the present disclosure, noises outside the population may be removed by point cloud denoising, and a uniformity of point clouds in the population is guaranteed by voxel downsampling.

In the embodiment of the present disclosure, through the preprocessing step, the direction of the point clouds in the population is the normal direction of the ground point cloud, such that the plant in each grid in subsequent analysis has the same direction, and the plant height uniformity can reflect the uniformity of the target crop population better. Meanwhile, for a large range of data, the method for calculating the plant height uniformity has the population universality through the preprocessing step in the embodiment of the present disclosure.

In the embodiment of the present disclosure, Step 130 includes:

A row spacing and a plant spacing of each target crop plot are acquired.

The 3D point cloud data of each target crop plot is divided into multiple rows according to the row spacing to obtain a row divided result. The 3D point cloud data of each target crop plot is divided into multiple columns according to the plant spacing to obtain a column divided result.

The target crop grids are determined according to the row divided result and the column divided result for the 3D point cloud data of each target crop plot. The target crop grid includes a length taken as the row spacing, and a width taken as the plant spacing.

Specifically, in case of uniform planting of crops in the plots, one plot includes m rows*n columns of plants. With the method in the embodiment of the present disclosure, the point cloud of the whole plot is uniformly divided into m rows*n columns. The length and the width of each grid are the row spacing and the plant spacing of the plot in planting. In the embodiment of the present disclosure, through the above step, the point cloud in each grid is taken as the point cloud of one crop plant. Since the crops cannot be planted in an ideally and absolutely uniform manner in the field, the method in the embodiment of the present disclosure can overcome the analytical error of the point cloud due to the actual non-uniform planting. By analyzing the point cloud of the grid, the height of the point cloud of the grid can correspond to the plant height of the plant, thereby improving the calculation accuracy of the uniformity.

In the embodiment of the present disclosure, Step 140 may include:

A height characteristic index of the target crop grid is determined according to the 3D point cloud data of the target crop grid. The height characteristic index is used for describing a target crop height in the target crop grid.

The plant height uniformity of each target crop plot is determined according to the height characteristic index of each target crop grid in each target crop plot.

That a height characteristic index of the target crop grid is determined according to the 3D point cloud data of the target crop grid includes:

The 3D point cloud data of the target crop grid is sorted according to heights.

The height characteristic index is determined as a height value of a preset quantile according to a height sorted result.

In the embodiment of the present disclosure, the preset quantile may be set according to species of the target crops. The preset quantile may be 90-98%, preferably 95%. In the embodiment of the present disclosure, the plant height is determined through the preset quantile rather than a highest point in the point cloud, which can overcome the instability of the plant height caused by a data noise. Meanwhile, this considers the interference of lateral growth of the crops on the distribution of the point clouds, and make a distribution of height characteristic indexes accord with a distribution of actual plant heights.

In the embodiment of the present disclosure, that the plant height uniformity of each target crop plot is determined according to the height characteristic index of each target crop grid in each target crop plot specifically includes:

It is assumed that there are N target crop grids in some plot, and each grid has the height characteristic index of hᵢ, 1≤i≤N. The mean is

$$\overline{h} = \frac{1}{N} {\sum }_{1}^{N} {h}_{i} .$$

The plant height uniformity is expressed as:

$$u = \frac{1}{N \overline{h}} {\sum }_{1}^{N} ( {h}_{i} - \overline{h} )$$

For the uniformity u, the value getting closer to zero indicates more uniform plant heights in the crop population. The greater the value, the less uniform the plant heights in the crop population.

In another embodiment of the present disclosure, Step 140 may include:

A height characteristic index of the target crop grid is determined according to the 3D point cloud data of the target crop grid. The height characteristic index is used for describing a target crop height in the target crop grid.

The plant height uniformity of each target crop plot is determined according to a height characteristic index of a first grid in each target crop plot.

The first grid is determined as follows:

At least one head row of target crop grids and at least one tail row of target crop grids are removed in the row divided result, and at least one head column of target crop grids and at least one tail column of target crop grids are removed in the column divided result, thereby obtaining the first grid.

That a height characteristic index of the target crop grid is determined according to the 3D point cloud data of the target crop grid includes:

The 3D point cloud data of the target crop grid is sorted according to heights.

The height characteristic index is determined as a height value of a preset quantile according to a height sorted result.

In the embodiment of the present disclosure, the preset quantile may be set according to species of the target crops. The preset quantile may be 90-98%, preferably 95%. In the embodiment of the present disclosure, the plant height is determined through the preset quantile rather than a highest point in the point cloud, which can overcome the instability of the plant height caused by a data noise. Meanwhile, this considers the interference of lateral growth of the crops on the distribution of the point clouds, and makes a distribution of height characteristic indexes accord with a distribution of actual plant heights.

That the plant height uniformity of each target crop plot is determined according to a height characteristic index of a first grid in each target crop plot specifically includes:

It is assumed that there are N first grids in some plot, and each grid has the height characteristic index of hᵢ, 1≤i≤N. The mean is

$$\overline{h} = \frac{1}{N} {\sum }_{1}^{N} {h}_{i} .$$

The plant height uniformity is expressed as:

$$u = \frac{1}{N \overline{h}} {\sum }_{1}^{N} ( {h}_{i} - \overline{h} )$$

For the uniformity u, the value getting closer to zero indicates more uniform plant heights in the crop population. The greater the value, the less uniform the plant heights in the crop population.

In the embodiment of the present disclosure, multiple rows and columns of crop plants outside the length and the width of the plot are removed uniformly, and only data of plants in the plot are used to calculate the uniformity. This removes the edge effect caused by arrangement of the plants in the plot, and calculates the plant height uniformity more accurately.

According to the method for calculating a plant height uniformity of a crop population provided by the embodiment of the present disclosure, a target crop population is segmented into plots, and the plot is segmented into grids. Since a number of target crop grids is the same as a number of target crop plants in each target crop plot, a plant height uniformity of each target crop plot can be determined according to 3D point cloud data of the grid, thereby determining a uniformity of the target crop population. The present disclosure realizes automatic and high-spatial-resolution uniformity calculation based on the point cloud data, improves the calculation efficiency, reduces the labor cost, and can expand the calculation area. Meanwhile, the present disclosure can realize non-contact calculation, thereby further improving the availability of the uniformity calculated result.

The apparatus for calculating a plant height uniformity of a crop population provided by the present disclosure will be described below. The following description on the apparatus for calculating a plant height uniformity of a crop population and the above description on the method for calculating a plant height uniformity of a crop population may refer to each other.

FIG. 2 is a schematic structural view of an apparatus for calculating a plant height uniformity of a crop population according to the present disclosure. As shown in FIG. 2, the apparatus for calculating a plant height uniformity of a crop population includes: a data acquisition module 210, a plot segmentation module 220, a grid module 230, and a uniformity module 240.

The data acquisition module 210 is configured to acquire 3D point cloud data of a target crop population.

The plot segmentation module 220 is configured to segment the 3D point cloud data of the target crop population to obtain 3D point cloud data of each target crop plot.

The grid module 230 is configured to determine target crop grids according to the 3D point cloud data of each target crop plot, a number of target crop grids being the same as a number of target crop plants in each target crop plot.

The uniformity module 240 is configured to determine a plant height uniformity of each target crop plot according to 3D point cloud data of the target crop grid.

According to the apparatus for calculating a plant height uniformity of a crop population provided by the embodiment of the present disclosure, a target crop population is segmented into plots, and the plot is segmented into grids. Since a number of target crop grids is the same as a number of target crop plants in each target crop plot, a plant height uniformity of each target crop plot can be determined according to 3D point cloud data of the grid, thereby determining a uniformity of the target crop population. The present disclosure realizes automatic and high-spatial-resolution uniformity calculation based on the point cloud data, improves the calculation efficiency, reduces the labor cost, and can expand the calculation area. Meanwhile, the present disclosure can realize non-contact calculation, thereby further improving the availability of the uniformity calculated result.

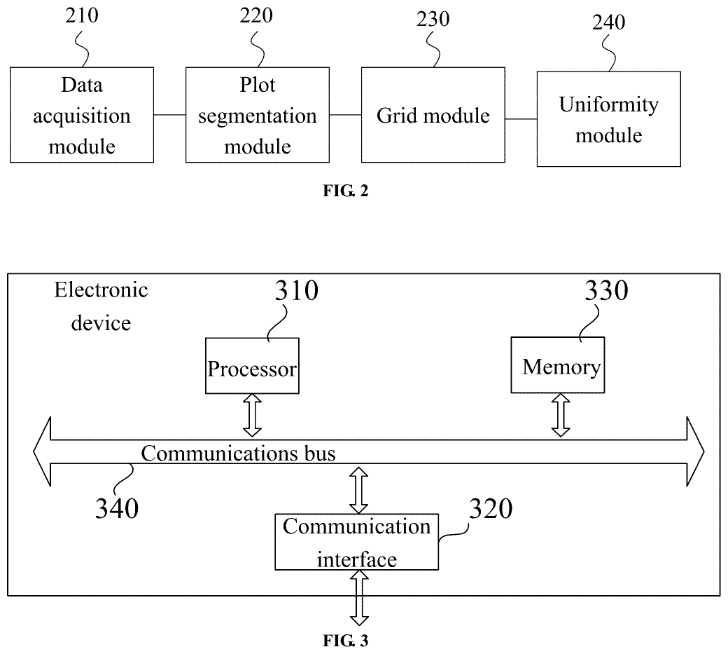

FIG. 3 illustrates a schematic view of a physical structure of an electronic device. As shown in FIG. 3, the electronic device may include: a processor 310, a communications interface 320, a memory 330, and a communication bus 340. The processor 310, the communications interface 320 and the memory 330 are in communication with one another by means of the communication bus 340. The processor 310 may be configured to invoke a logic instruction in the memory 330 to execute the method for calculating a plant height uniformity of a crop population, which includes the following steps:

3D point cloud data of a target crop population is acquired.

The 3D point cloud data of the target crop population is segmented to obtain 3D point cloud data of each target crop plot.

Target crop grids are determined according to the 3D point cloud data of each target crop plot, a number of target crop grids being the same as a number of target crop plants in each target crop plot.

A plant height uniformity of each target crop plot is determined according to 3D point cloud data of the target crop grid.

Besides, the logic instruction in the memory 330 may be implemented as a software function unit and be stored in a computer-readable storage medium when sold or used as a separate product. On the basis of such understanding, the technical solutions of the present disclosure essentially or the part contributing to the prior art or the part of the technical solutions may be embodied in a form of a software product. The computer software product is stored in a storage medium, and includes several instructions for enabling a computer device (which may be a personal computer, a server, a network device, etc.) to execute all or some steps of the methods described in the embodiments of the present disclosure. The foregoing storage medium includes various media capable of storing a program code, such as a USB flash disk, a mobile hard disk, a read-only memory (ROM), a random access memory (RAM), a magnetic disk, and an optical disc.

In another aspect, the present disclosure further provides a computer program product. The computer program product includes a computer program. The computer program may be stored in a non-transitory computer-readable storage medium. When the computer program is executed by a processor, a computer may execute the method for calculating a plant height uniformity of a crop population, which includes the following steps:

3D point cloud data of a target crop population is acquired.

The 3D point cloud data of the target crop population is segmented to obtain 3D point cloud data of each target crop plot.

Target crop grids are determined according to the 3D point cloud data of each target crop plot, a number of target crop grids being the same as a number of target crop plants in each target crop plot.

A plant height uniformity of each target crop plot is determined according to 3D point cloud data of the target crop grid.

In yet another aspect, the present disclosure further provides a non-transitory computer-readable storage medium. The non-transitory computer-readable storage medium stores a computer program. When the computer program is executed by a processor, the method for calculating a plant height uniformity of a crop population is implemented, which includes the following steps:

3D point cloud data of a target crop population is acquired.

The 3D point cloud data of the target crop population is segmented to obtain 3D point cloud data of each target crop plot.

Target crop grids are determined according to the 3D point cloud data of each target crop plot, a number of target crop grids being the same as a number of target crop plants in each target crop plot.

A plant height uniformity of each target crop plot is determined according to 3D point cloud data of the target crop grid.

The apparatus embodiment described above is merely schematic, where the unit described as a separate component may or may not be physically separated, and a component displayed as a unit may or may not be a physical unit, that is, the component may be located at one place, or distributed on multiple network units. Some or all of the modules may be selected based on actual needs to achieve the objectives of the solutions of the embodiments. A person of ordinary skill in the art can understand and implement the embodiments without creative efforts.

Through the description of the foregoing implementations, a person skilled in the art can clearly understand that the implementations can be implemented by means of software plus a necessary universal hardware platform, or certainly, can be implemented by hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disc, including a plurality of instructions for causing a computer device (which may be a personal computer, a server, or a network device) to perform the methods described in the embodiments or some parts of the embodiments.

Finally, it should be noted that the above embodiments are only intended to illustrate, but not to limit, the technical solutions of the present disclosure. Although the present disclosure has been described in detail with reference to the foregoing embodiments, those of ordinary skill in the art should understand that: The technical solutions recorded in the foregoing embodiments may be still modified, or some of the technical features may be equivalently substituted. These modifications or substitutions do not cause the essence of the corresponding technical solutions to depart from the spirit and scope of the technical solutions of the embodiments of the present disclosure.

What is claimed is:

1. A method for calculating a plant height uniformity of a crop population, comprising following steps:
acquiring three-dimensional (3D) point cloud data of a target crop population;
segmenting the 3D point cloud data of the target crop population to obtain 3D point cloud data of each target crop plot;
determining target crop grids according to the 3D point cloud data of each target crop plot, a number of target crop grids being the same as a number of target crop plants in each target crop plot; and
determining a plant height uniformity of each target crop plot according to 3D point cloud data of the target crop grid.

2. The method for calculating a plant height uniformity of a crop population according to claim 1, after the acquiring 3D point cloud data of a target crop population, further comprising a preprocessing step, specifically:
determining a ground point cloud according to the 3D point cloud data of the target crop population;
determining a normal direction of the ground point cloud as a reference direction, and rotating the 3D point cloud data of the target crop population, such that a direction of the 3D point cloud data of the target crop population is the same as the reference direction; and
removing the ground point cloud in the 3D point cloud data of the target crop population.

3. The method for calculating a plant height uniformity of a crop population according to claim 1, wherein the determining target crop grids according to the 3D point cloud data of each target crop plot comprises:
acquiring a row spacing and a plant spacing of each target crop plot;
dividing the 3D point cloud data of each target crop plot into multiple rows according to the row spacing to obtain a row divided result; and dividing the 3D point cloud data of each target crop plot into multiple columns according to the plant spacing to obtain a column divided result; and
determining the target crop grids according to the row divided result and the column divided result for the 3D point cloud data of each target crop plot, the target crop grid comprising a length taken as the row spacing, and a width taken as the plant spacing.

4. The method for calculating a plant height uniformity of a crop population according to claim 3, wherein the determining a plant height uniformity of each target crop plot according to 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to the height characteristic index of each target crop grid in each target crop plot.

5. The method for calculating a plant height uniformity of a crop population according to claim 3, wherein the determining a plant height uniformity of each target crop plot according to the 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to a height characteristic index of a first grid in each target crop plot, wherein
the first grid is determined as follows:
removing at least one head row of target crop grids and at least one tail row of target crop grids in the row divided result, and removing at least one head column of target crop grids and at least one tail column of target crop grids in the column divided result, thereby obtaining the first grid.

6. The method for calculating a plant height uniformity of a crop population according to claim 4, wherein the determining a height characteristic index of the target crop grid according to the 3D point cloud data of the target crop grid comprises:
sorting the 3D point cloud data of the target crop grid according to heights; and
determining the height characteristic index as a height value of a preset quantile according to a height sorted result.

7. An apparatus for calculating a plant height uniformity of a crop population, comprising:
a data acquisition module configured to acquire three-dimensional (3D) point cloud data of a target crop population;
a plot segmentation module configured to segment the 3D point cloud data of the target crop population to obtain 3D point cloud data of each target crop plot;
a grid module configured to determine target crop grids according to the 3D point cloud data of each target crop plot, a number of target crop grids being the same as a number of target crop plants in each target crop plot; and
a uniformity module configured to determine a plant height uniformity of each target crop plot according to 3D point cloud data of the target crop grid.

8. An electronic device, comprising a memory, a processor, and a computer program stored in the memory and executable on the processor, wherein when the program is executed by the processor, the method for calculating a plant height uniformity of a crop population according to claim 1 is implemented.

9. A non-transitory computer-readable storage medium, storing a computer program, wherein when the computer program is executed by a processor, the method for calculating a plant height uniformity of a crop population according to claim 1 is implemented.

10. The method for calculating a plant height uniformity of a crop population according to claim 5, wherein the determining a height characteristic index of the target crop grid according to the 3D point cloud data of the target crop grid comprises:
sorting the 3D point cloud data of the target crop grid according to heights; and
determining the height characteristic index as a height value of a preset quantile according to a height sorted result.

11. The electronic device according to claim 8, after the acquiring 3D point cloud data of a target crop population, further comprising a preprocessing step, specifically:
determining a ground point cloud according to the 3D point cloud data of the target crop population;
determining a normal direction of the ground point cloud as a reference direction, and rotating the 3D point cloud data of the target crop population, such that a direction of the 3D point cloud data of the target crop population is the same as the reference direction; and
removing the ground point cloud in the 3D point cloud data of the target crop population.

12. The electronic device according to claim 8, wherein the determining target crop grids according to the 3D point cloud data of each target crop plot comprises:
acquiring a row spacing and a plant spacing of each target crop plot;
dividing the 3D point cloud data of each target crop plot into multiple rows according to the row spacing to obtain a row divided result; and dividing the 3D point cloud data of each target crop plot into multiple columns according to the plant spacing to obtain a column divided result; and
determining the target crop grids according to the row divided result and the column divided result for the 3D point cloud data of each target crop plot, the target crop grid comprising a length taken as the row spacing, and a width taken as the plant spacing.

13. The electronic device according to claim 12, wherein the determining a plant height uniformity of each target crop plot according to 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to the height characteristic index of each target crop grid in each target crop plot.

14. The electronic device according to claim 12, wherein the determining a plant height uniformity of each target crop plot according to the 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to a height characteristic index of a first grid in each target crop plot, wherein
the first grid is determined as follows:
removing at least one head row of target crop grids and at least one tail row of target crop grids in the row divided result, and removing at least one head column of target crop grids and at least one tail column of target crop grids in the column divided result, thereby obtaining the first grid.

15. The electronic device according to claim 13, wherein the determining a height characteristic index of the target crop grid according to the 3D point cloud data of the target crop grid comprises:
sorting the 3D point cloud data of the target crop grid according to heights; and
determining the height characteristic index as a height value of a preset quantile according to a height sorted result.

16. The non-transitory computer-readable storage medium according to claim 9, after the acquiring 3D point cloud data of a target crop population, further comprising a preprocessing step, specifically:
determining a ground point cloud according to the 3D point cloud data of the target crop population;
determining a normal direction of the ground point cloud as a reference direction, and rotating the 3D point cloud data of the target crop population, such that a direction of the 3D point cloud data of the target crop population is the same as the reference direction; and
removing the ground point cloud in the 3D point cloud data of the target crop population.

17. The non-transitory computer-readable storage medium according to claim 9, wherein the determining target crop grids according to the 3D point cloud data of each target crop plot comprises:
acquiring a row spacing and a plant spacing of each target crop plot;
dividing the 3D point cloud data of each target crop plot into multiple rows according to the row spacing to obtain a row divided result; and dividing the 3D point cloud data of each target crop plot into multiple columns according to the plant spacing to obtain a column divided result; and
determining the target crop grids according to the row divided result and the column divided result for the 3D point cloud data of each target crop plot, the target crop grid comprising a length taken as the row spacing, and a width taken as the plant spacing.

18. The non-transitory computer-readable storage medium according to claim 17, wherein the determining a plant height uniformity of each target crop plot according to 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to the height characteristic index of each target crop grid in each target crop plot.

19. The non-transitory computer-readable storage medium according to claim 17, wherein the determining a plant height uniformity of each target crop plot according to the 3D point cloud data of the target crop grid comprises:
determining a height characteristic index of the target crop grid according to the 3D point cloud data of the target crop grid, the height characteristic index being used for describing a target crop height in the target crop grid; and
determining the plant height uniformity of each target crop plot according to a height characteristic index of a first grid in each target crop plot, wherein
the first grid is determined as follows:
removing at least one head row of target crop grids and at least one tail row of target crop grids in the row divided result, and removing at least one head column of target crop grids and at least one tail column of target crop grids in the column divided result, thereby obtaining the first grid.

20. The non-transitory computer-readable storage medium according to claim 18, wherein the determining a height characteristic index of the target crop grid according to the 3D point cloud data of the target crop grid comprises:
sorting the 3D point cloud data of the target crop grid according to heights; and
determining the height characteristic index as a height value of a preset quantile according to a height sorted result.
